(19) United States
(12) Patent Application Publication
(10) Pub. No.: US 2010/0077916 A1
(43) Pub. Date: Apr. 1, 2010

(54) HYDRAULIC CYLINDER WITH CUSHION

(76) Inventor: LARRY BRUNN, PHOENIX, AZ (US)

Correspondence Address: ROBERT A. PARSONS, 4000 N. CENTRAL AVENUE, SUITE 1220, PHOENIX, AZ, 85012, US

(21) Appl. No.: 12/243,421

(22) Filed: Oct. 1, 2008

(51) Int. Cl. F15B 15/22

(52) U.S. Cl. 91/396; 91/409; 92/85 B

(57) ABSTRACT

A cushioned hydraulic cylinder assembly including a hydraulic cylinder having a reciprocating piston movable between an extended position and a retracted position and a hydraulic fluid port proximate an end thereof for ingress and egress of hydraulic fluid. A cushion member is carried by the piston, wherein the cushion member obstructs hydraulic fluid flow out of the port in the retracted position and is spaced from the port in the extended position. A continuous spiral groove is formed in an outer surface of the cushion member and has a beginning at a first end of the cushion member away from the piston and terminates proximate a second end adjacent the piston. The beginning of the spiral groove has a cross-sectional volume, the cross-sectional volume decreasing toward the second end of the cushion member. The spiral groove gradually reduces hydraulic fluid flow out of the port as the piston moves toward the retracted position.

### FIELD OF THE INVENTION

This invention relates to hydraulic cylinders.

More particularly, the present invention relates to apparatus for cushioning the end travel of a hydraulic cylinder piston.

### BACKGROUND OF THE INVENTION

In the field of hydraulic cylinders, it is desirable to lessen the shock of impact at the end of a piston stroke. An abrupt stopping of the piston against the cylinder end can adversely impact the integrity of the piston and the cylinder. Additionally, an abrupt cessation of movement to the piston rod can have an adverse effect on the mechanism the hydraulic cylinder is powering.

To reduce the shock of an abruptly stopped piston stroke, many and varied mechanisms have been employed. These mechanisms often include complicated many part assembly which regulate through valves and the like, the release of fluid from the cylinder. These mechanisms are difficult to adjust, and temperamental in operation and maintenance. Pieces can break, clog and generally make operation of the cylinder inefficient and troublesome. Simply mechanisms have also been employed, such as bumper elements which are formed of resilient material carried at the ends of the hydraulic cylinder. These elements simply receive the piston at the end of the stroke and absorb the shock of impact. While somewhat effective, these devices can lose their resilience over time and degrade under use. Again, maintenance and repair become a constant requirement.

It would be highly advantageous, therefore, to remedy the foregoing and other deficiencies inherent in the prior art.

An object of the present invention is to provide a reliable and effective cushion for hydraulic cylinders.

Another object of the present invention is to provide a cushion for hydraulic cylinders which are robust and require a minimum of maintenance.

### SUMMARY OF THE INVENTION

Briefly, to achieve the desired objects and advantages of the instant invention in accordance with a preferred embodiment thereof, provided is a cushioned hydraulic cylinder assembly including a hydraulic cylinder having a reciprocating piston movable between an extended position and a retracted position, and a hydraulic fluid port proximate an end thereof for ingress and egress of hydraulic fluid. A cushion member is carried by the piston, wherein the cushion member obstructs hydraulic fluid flow out of the port in the retracted position and is spaced from the port in the extended position. A continuous spiral groove is formed in an outer surface of the cushion member, the spiral groove having a beginning at a first end of the cushion member away from the piston, and terminating proximate a second end adjacent the piston. The beginning of the spiral groove has a cross-sectional volume which decreases toward the second end of the cushion member. The spiral groove gradually reduces hydraulic fluid flow therethrough and out the port as the piston moves toward the retracted position.

In another aspect of the present invention, the hydraulic cylinder has a second hydraulic fluid port proximate an opposing end thereof for ingress and egress of hydraulic fluid. Another cushion member is carried by the piston opposite the cushion member, wherein this cushion member obstructs hydraulic fluid flow out of the opposing port in the extended position and is spaced from the port in the retracted position. A continuous spiral groove is also formed in an outer surface of this cushion member. The spiral groove has a beginning at a first end of this cushion member away from the piston, and terminating proximate a second end adjacent the piston. The beginning of the spiral groove has a cross-sectional volume, the cross-sectional volume decreasing toward the second end of this cushion member. The spiral groove gradually reduces hydraulic fluid flow therethrough and out the opposing port as the piston moves toward the extended position.

In yet another aspect of the present invention, a cushioned hydraulic cylinder assembly includes a cylinder having an inner surface defining a volume, a first end and a second end, a first fluid port formed in the cylinder proximate the first end and in fluid communication with the volume and a second fluid port formed in the cylinder proximate the second end and in fluid communication with the volume. A piston head is carried in the volume for reciprocating movement toward the first end of the cylinder to a retracted position and toward the second end of the cylinder to an extended position. A first cushion member is carried by the piston head between the piston head and the first end of the cylinder. The first cushion member has a first end adjacent the piston head, a second end away from the piston head, and an outer surface extending therebetween and closely adjacent the inner surface of the cylinder. The first cushion member is movable with the piston head between a position away from the first end and a position spaced from the first fluid port to a position overlying and obstructing the first fluid port. A first continuous spiral groove is formed in the outer surface of the first cushion member. The first spiral groove has a beginning at the second end of the first cushion member and terminates proximate the first end. The beginning of the first spiral groove has a cross-sectional volume which decreases toward the first end of the first cushion member to gradually inhibit fluid flow through the first fluid port as the first cushion member moves to the position overlying the fluid port. A second cushion member is carried by the piston head between the piston head and the second end of the cylinder. The second cushion member has a first end adjacent the piston head, an opposing second end, and an outer surface extending therebetween and closely overlying the inner surface of the cylinder. The second cushion member is movable with the piston head between a position away from the second end and a positioned spaced from the second fluid port to a position overlying and blocking the second fluid port. A second continuous spiral groove is formed in the outer surface of the second cushion member. The second spiral groove has a beginning at the second end of the second cushion member and terminates proximate the first end. The beginning of the second spiral groove has a cross-sectional volume which decreases toward the first end of the second cushion member to gradually inhibit fluid flow through the second fluid port as the second cushion member moves to the position overlying the second fluid port.

### BRIEF DESCRIPTION OF THE DRAWINGS

Specific objects and advantages of the instant invention will become readily apparent to those skilled in the art from the following detailed description of a preferred embodiment thereof taken in conjunction with the drawings, in which:

FIG. 1 is a perspective view of a double acting hydraulic cylinder;

FIG. 2 is a sectional side view of the double acting cylinder in the retracted position;

FIG. 3 is an enlarged sectional side view of a fixed end of the double acting hydraulic cylinder of FIGS. 1 and 2;

FIG. 4 is a sectional side view of the double acting cylinder in the extended position;

FIG. 5 is an enlarged sectional side view of a piston shaft receiving end of the double acting hydraulic cylinder of FIG. 4;

FIG. 6 is an exploded side view of a piston head with cushion members according to the present invention; and

FIG. 7a-7c are partial sectional side views of the piston shaft end with the piston moving progressively toward the extended position in the cushioning region.

### DETAILED DESCRIPTION OF THE PREFERRED EMBODIMENTS

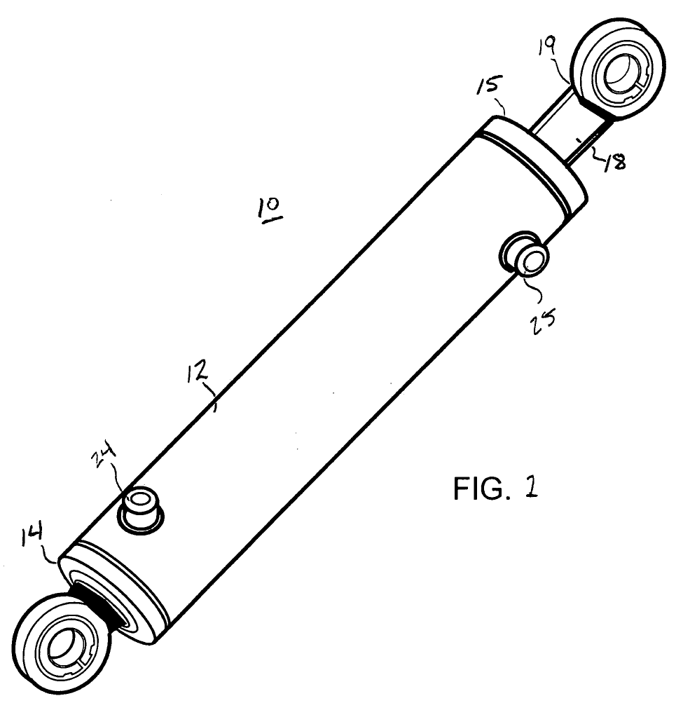

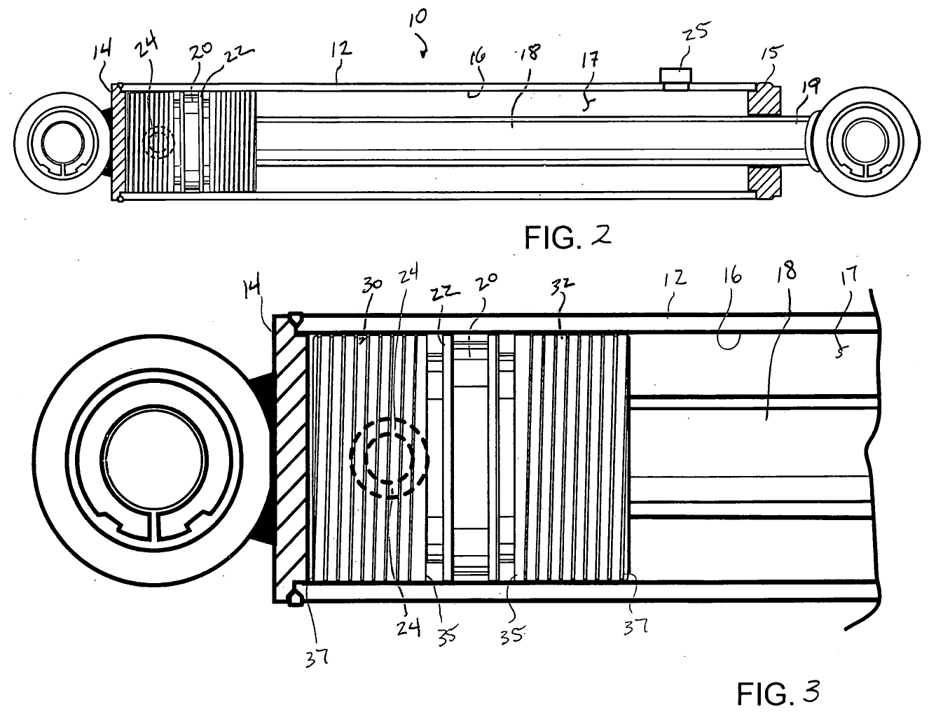

Turning now to the drawings in which like reference characters indicate corresponding elements throughout the several views, attention is first directed to FIGS. 1 and 2 which illustrate a double acting hydraulic cylinder assembly 10. A double acting hydraulic cylinder assembly is a piston driven motor moveable between extended and retracted positions by increasing the volume of hydraulic fluid on one side of a piston while reducing the volume of hydraulic fluid on the opposing side. In this manner, double acting hydraulic cylinder assembly 10 can be driven to both the extended position and the retracted position.

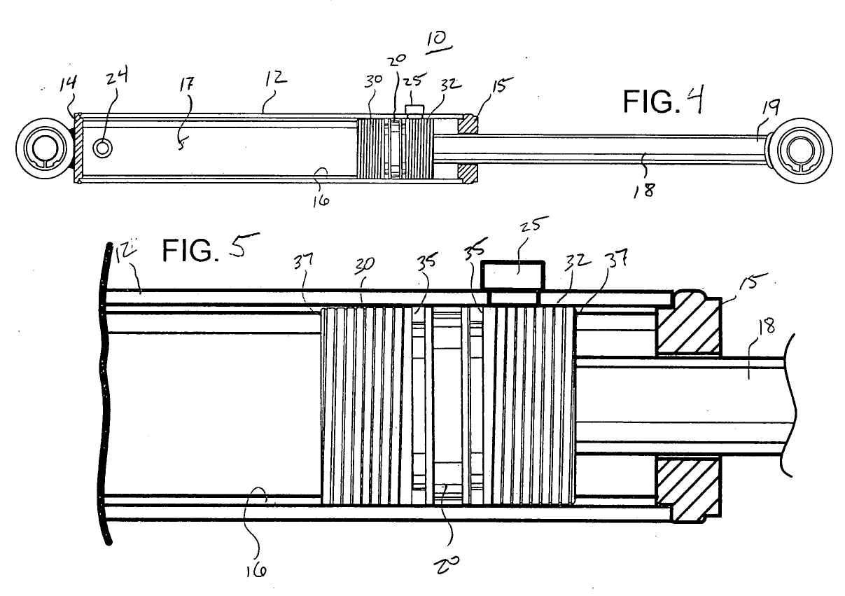

Cylinder assembly 10 includes a cylinder 12 with a closed end 14, an opposing piston rod receiving end 15 and an inner surface 16 defining a volume 17. A piston rod 18 extends from end 15 and includes an end 19 extending outwardly from cylinder 12 and couplable as desired in a well known manner common to double acting hydraulic cylinder assemblies, and an opposing end terminating in a piston head 20. Piston head 20 is carried within volume 17 and has an outer diameter closely matching the diameter of inner surface 16 to allow reciprocating movement therealong, and is typically sealed against inner surface 16 of cylinder 12 by piston rings 22 forming a plug within volume 17 to prevent fluid transfer from one side of piston head 20 to the other within volume 17. In operation, as shown in FIGS. 2 and 3, piston head 20 is moved toward closed end 14 by ingress of hydraulic fluid through fluid port 25, and egress of hydraulic fluid from fluid port 24. By forcing hydraulic fluid into volume 17 through port 25 between piston head 20 and end 15, piston head 20 moves toward closed end 14 to a retracted position. Fluid in volume 17 between piston head 20 and closed end 14 is correspondingly forced out port 24, permitting this movement. Conversely, as shown in FIGS. 4 and 5, forcing hydraulic fluid into volume 17 through port 24 between piston head 20 and closed end 14 causes piston head 20 to move toward end 15, into an extended position. Fluid in volume 17 between piston head 20 and end 15 is correspondingly forced out port 25, permitting this movement.

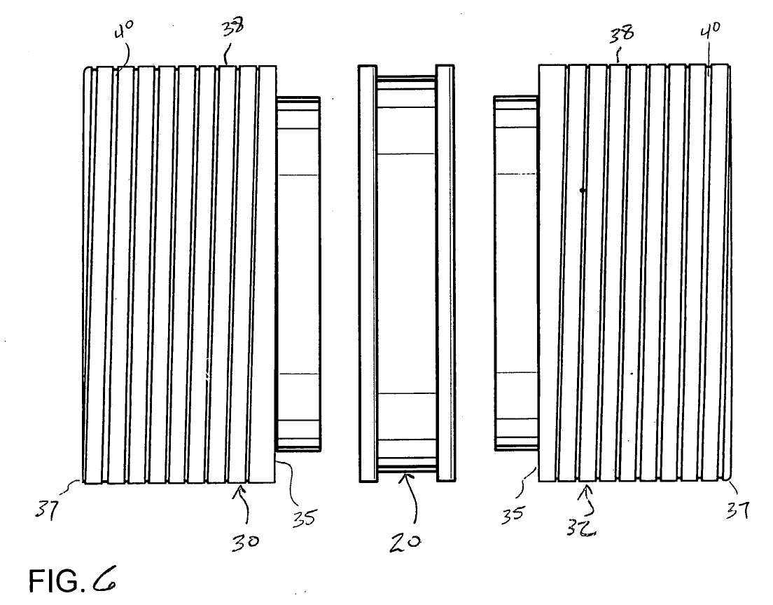

Still referring to FIGS. 2-5, with additional reference to FIG. 6, a piston head assembly including piston head 20 and cushion members 30 and 32 carried on opposing sided thereof, is illustrated. Cushion member 30 is carried by piston head 20 between piston head 20 and closed end 14, and cushion member 32 is carried by piston head 20 between piston head 20 and end 15. In this embodiment, cushion members 30 and 32 are separate cylindrical shaped elements carried by opposing faces of piston head 20. This can be achieved by affixing cushion members 30 and 32 directly to piston head 20 such as by bolts or other fasteners, adhesives, welds, and the like, or attachment to piston rod 18 to either side of piston head 20. It is also contemplated that cushion members 30 and 32 can be formed integrally with piston head 20 in a one-piece construction. However attached, cushion members 30 and 32 move with piston head 20 and act as plugs within volume 17 to prevent movement of fluid therepast except as will be described presently. Cushion members 30 and 32 can be formed of substantially any material which can withstand the forces generated within cylinder 12, such as plastics, metals such as aluminum and steel, and the like.

Each cushion member 30 and 32 has an end 35 adjacent piston head 20, an opposing end 37, and an outer surface 38 extending therebetween and closely adjacent inner surface 16 of cylinder 12. Cushion member 30 is movable with piston head 20 between a position away from closed end 14 (the extended position) and spaced from fluid port 24 (FIGS. 4 and 5) to a position overlying and obstructing fluid port 24 (the retracted position as shown in FIGS. 2 and 3). As cushion members 30 and 32 move to the extended or to the retracted positions with piston head 20, they begin obstructing ports 25 or 24, respectively. Initially the ports are unobstructed and fluid can flow out easily without hindrance. At this point in the piston stroke, piston head 20 moves easily toward one of the extended or retracted positions. As the opposing end 37 of the relevant cushion 30 and 32 reaches ports 24 or 25, the fluid egress is hindered until the amount of fluid which can exit the port is greatly reduced. This is accomplished in a graded manner, as will be described presently, so as to gradually stop the piston movement, whether retracting or extending, thereby cushioning the piston at the end of the stroke. To begin a piston stroke, it will be understood that some fluid can be forced into volume 17 past the obstructing cushion members even though that flow is greatly reduced from the unobstructed port. As fluid enters volume 17, the obstructing cushion member is forced toward the opposing end, along greater fluid entry and an increasingly unobstructed port.

Still referring to FIG. 6, a continuous spiral groove 40 is formed in outer surface 38 of cushion member 30 and cushion member 32. Each cushion member 30 and 32 acts as a plug within volume 17 preventing hydraulic fluid flow from end 37 to end 35 except through spiral groove 40. Spiral groove 40 begins at opposing end 37 of cushion members 30 and 32, and terminates proximate end 35. Spiral groove 40, beginning at opposing end 37 has a cross-sectional volume. The cross-sectional volume decreases along spiral groove 40 toward end 35 of cushion members 30 and 32 to gradually inhibit fluid flow through the fluid port as the cushion member moves to the position overlying the fluid port. It will be understood that the cross-sectional shape of groove 40 can vary as desired, being wide and shallow, narrow and deep, etc. as long as the cross-sectional volume is sufficient to allow fluid to pass therethrough at a desired level for the start of the cushioning action. As spiral groove 40 progresses toward end 35, the cross-sectional volume can be decreased by narrowing, reducing the depth, or combinations thereof.

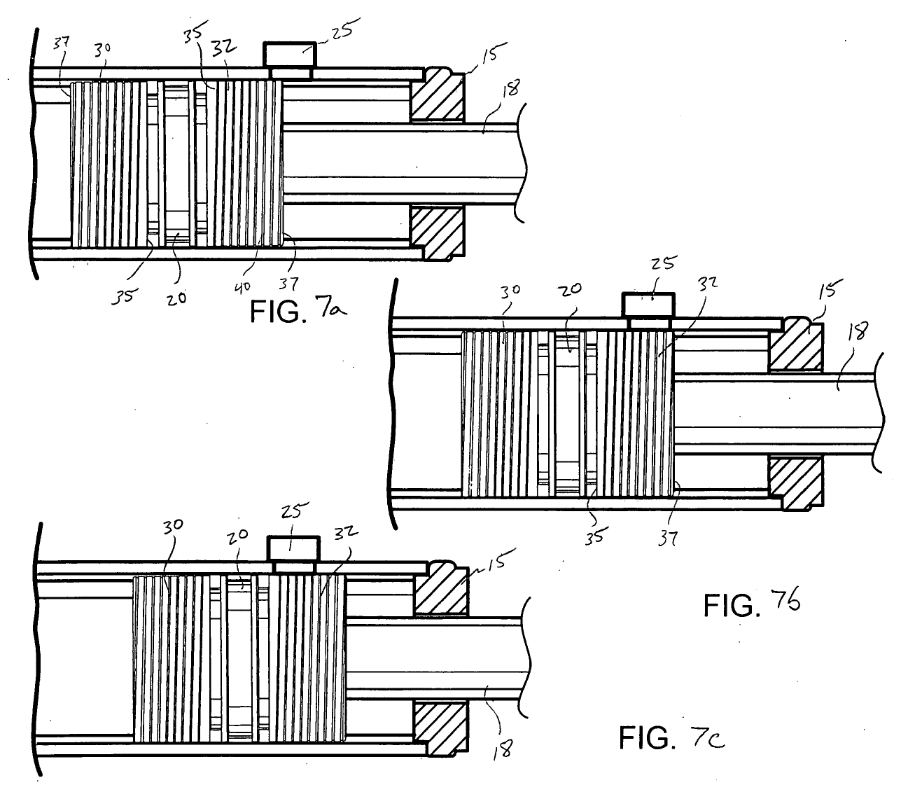

Referring now to FIGS. 7a-7b, a cushioning action is illustrated at the end of a piston stroke wherein the piston is moving to the extended position. In FIG. 7a, piston 20 has moved most of the way toward end 15 and the extended position, with hydraulic fluid being forced out port 25 with no hindrance. As end 37 of cushion member 32 reaches port 25, the amount of fluid exiting begins to reduce as the port is obstructed. Referring to FIG. 7b, port 25 is fully obstructed by cushion member 32, and fluid reaching port 25 is only that fluid which enters spiral groove 40 at end 37 of cushion member 32. As cushion member 32 progresses further toward end 15 of cylinder 12, port 25 is obstructed increasing by cushion member 32 towards end 35. Since the cross-sectional volume of spiral groove 40 proximate end 35 is greatly reduced, little or no fluid can exit port 25. This is then the fully extended position. Since the fluid remaining between piston head 20 and end 15 can no longer exit cylinder 12, the piston stroke has ended. Since the fluid exiting port 25 was gradually reduced at the end of the stroke, the piston reached the end of the stroke gradually as opposed to abruptly and was therefore cushioned. It will be understood by one skilled in the art that cushion member 30 operates in the same manner for the piston stroke in the opposite direction, moving to the retracted position.

While a double acting hydraulic cylinder has been described and illustrated in this preferred embodiment, one skilled in the art will understand that a single cushion member can be used with a single acting hydraulic cylinder to cushion a piston stoke returning to the retracted position.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A cushioned hydraulic cylinder assembly comprising:
a hydraulic cylinder having a reciprocating piston movable between an extended position and a retracted position, and a hydraulic fluid port proximate an end thereof for ingress and egress of hydraulic fluid;
a cushion member carried by the piston, wherein the cushion member obstructs hydraulic fluid flow out of the port in the retracted position and is spaced from the port in the extended position; and
a continuous spiral groove formed in an outer surface of the cushion member, the spiral groove having a beginning at a first end of the cushion member away from the piston, and terminating proximate a second end adjacent the piston, the beginning of the spiral groove having a cross-sectional volume, the cross-sectional volume decreasing toward the second end of the cushion member, the spiral groove gradually reducing hydraulic fluid flow therethrough and out the port as the piston moves toward the retracted position.

2. A cushioned hydraulic cylinder assembly as claimed in claim 1, further comprising:
the hydraulic cylinder having a second hydraulic fluid port proximate and opposing end thereof for ingress and egress of hydraulic fluid;
another cushion member carried by the piston opposite the cushion member, wherein the another cushion member obstructs hydraulic fluid flow out of the opposing port in the extended position and is spaced from the port in the retracted position; and
a continuous spiral groove formed in an outer surface of the another cushion member, the spiral groove having a beginning at a first end of the another cushion member away from the piston, and terminating proximate a second end adjacent the piston, the beginning of the spiral groove having a cross-sectional volume, the cross-sectional volume decreasing toward the second end of the another cushion member, the spiral groove gradually reducing hydraulic fluid flow therethrough and out the opposing port as the piston moves toward the extended position.

3. A cushioned hydraulic cylinder assembly comprising:
a cylinder having an inner surface defining a volume, a first end and a second end;
an fluid port formed in the cylinder proximate the first end and in fluid communication with the volume;
a piston head carried in the volume for reciprocating movement toward the first end and the second end of the cylinder, the piston head moveably engaging the inner surface of the cylinder;
a cushion member carried by the piston head between the piston head and the first end of the cylinder, the cushion member having a first end adjacent the piston head, an opposing second end, and an outer surface extending therebetween and closely adjacent the inner surface of the cylinder, the cushion member movable with the piston head between a position away from the first end and spaced from the fluid port to a position overlying and blocking the fluid port; and
a continuous spiral groove formed in the outer surface of the cushion member, the spiral groove having a beginning at the second end of the cushion and terminating proximate the first end, the beginning of the spiral groove having a cross-sectional volume, the cross-sectional volume decreasing toward the first end of the cushion member to gradually inhibit fluid flow through the fluid port as the cushion member moves to the position overlying the fluid port.

4. A cushioned hydraulic cylinder assembly as claimed in claim 3 further comprising:
a second fluid port formed in the cylinder proximate the second end and in fluid communication with the volume;
a second cushion member carried by the piston head between the piston head and the second end of the cylinder, the second cushion member having a first end adjacent the piston head, an opposing second end, and an outer surface extending therebetween and closely overlying the inner surface of the cylinder, the second cushion member movable with the piston head between a position away from the second end and spaced from the second fluid port to a position overlying and blocking the second fluid port; and
a continuous spiral groove formed in the outer surface of the second cushion member, the spiral groove having a beginning at the second end of the second cushion member and terminating proximate the first end, the beginning of the spiral groove having a cross-sectional volume, the cross-sectional volume decreasing toward the first end of the second cushion member to gradually inhibit fluid flow through the second fluid port as the second cushion member moves to the position overlying the second fluid port.

5. A cushioned hydraulic cylinder assembly as claimed in claim 4 further comprising a piston shaft extending from the piston head through one of the first cushion and second cushion and exiting the cylinder through one of the first end and the second end.

6. A cushioned hydraulic cylinder assembly comprising:
a cylinder having an inner surface defining a volume, a first end and a second end;
a first fluid port formed in the cylinder proximate the first end and in fluid communication with the volume;
a second fluid port formed in the cylinder proximate the second end and in fluid communication with the volume;
a piston head carried in the volume for reciprocating movement toward the first end of the cylinder to a retracted position and toward the second end of the cylinder to an extended position, the piston head moveably engaging the inner surface of the cylinder;
a first cushion member carried by the piston head between the piston head and the first end of the cylinder, the first cushion member having a first end adjacent the piston head, a second end away from the piston head, and an outer surface extending therebetween and closely adjacent the inner surface of the cylinder, the first cushion member movable with the piston head between a position away from the first end and spaced from the first fluid port to a position overlying and obstructing the first fluid port;
a first continuous spiral groove formed in the outer surface of the first cushion member, the first spiral groove having a beginning at the second end of the first cushion member and terminating proximate the first end, the beginning of the first spiral groove having a cross-sectional volume, the cross-sectional volume decreasing toward the first end of the first cushion member to gradually inhibit fluid flow through the first fluid port as the first cushion member moves to the position overlying the fluid port;
a second cushion member carried by the piston head between the piston head and the second end of the cylinder, the second cushion member having a first end adjacent the piston head, an opposing second end, and an outer surface extending therebetween and closely overlying the inner surface of the cylinder, the second cushion member movable with the piston head between a position away from the second end and spaced from the second fluid port to a position overlying and blocking the second fluid port; and
a second continuous spiral groove formed in the outer surface of the second cushion member, the second spiral groove having a beginning at the second end of the second cushion member and terminating proximate the first end, the beginning of the second spiral groove having a cross-sectional volume, the cross-sectional volume decreasing toward the first end of the second cushion member to gradually inhibit fluid flow through the second fluid port as the second cushion member moves to the position overlying the second fluid port.
